(19) United States
(12) Patent Application Publication
(10) Pub. No.: US 2019/0296409 A1
(43) Pub. Date: Sep. 26, 2019

(54) NOVEL ZINC AIR FUEL CELL WITH LONGEVITY

(71) Applicant: Joel Steven Goldberg, Hillsborough, NC (US)

(72) Inventor: Joel Steven Goldberg, Hillsborough, NC (US)

(21) Appl. No.: 16/435,479

(22) Filed: Jun. 8, 2019

(51) Int. Cl. H01M 12/06; H01M 4/38

(52) U.S. Cl. CPC H01M 12/06; H01M 2300/0002; H01M 4/38

(57) ABSTRACT

Performance of a zinc/saline/graphite fuel cell is described with a specific energy of 124 watt hours per kilogram of zinc, but with longevity of greater than 92 days. The chemistry of this fuel cell fundamentally differs from traditional zinc air fuel cells because the species of zinc hydroxychloride anions in solution [Zn(OH)₃Cl²⁻, Zn(OH)₂Cl₂²⁻, ZnOHCl₃²⁻] provide efficient waste management of Zn⁺² and OH⁻ ions, and thus the internal resistance of the cell rises slowly. The proposed chemistry of this fuel cell is: 3Zn₍ₛ₎+3/2O_{2(g)}+3H₂O+6NaCl₍ₛ₎→Zn(OH)₃Cl²⁻+Zn(OH)₂Cl₂²⁻+ZnOHCl₃²⁻+6Na⁺.

### FEDERAL FUNDING

None

### CROSS REFERENCE TO RELATED APPLICATION

US 2015/0037709 A1

### BACKGROUND OF THE INVENTION

There exists a great need for inexpensive sources of electricity that are independent from the electrical grid. Society has become so dependent upon electricity that disruption in service may have catastrophic effects on world order. In most of today's developed societies, “food (including water), clothing, and shelter” are not enough for sustenance and, more appropriately, this can be revised to “food (including water), clothing, shelter, and electricity”.

As population growth continues, underdeveloped societies become more developed, and as new uses of electricity are discovered, there exists a need for more inexpensive energy.

Electrical disruption is predicted from intense solar activity and electromagnetic pulses (EMP) generated by a high altitude nuclear weapon explosion. Such a detonation has the potential to destroy electrical devices and electrical supply lines which are not adequately shielded. The true extent of EMP has been theorized, and there are some reports from the United States and the former Soviet Union of electrical effects from a high altitude nuclear explosion. In addition to anti-ballistic missile and electrical shielding protection, national security should ensure methods to generate electricity at a residence or business in the event of an EMP. Fuel cells and batteries that are not connected to the electrical grid may be spared destruction from EMP, and simple (without microprocessors) and inexpensive fuel cells that can be constructed or purchased by the general population may provide national security in the event of an EMP.

It is unlikely that a nuclear free world will exist in the near future, and it is more likely additional countries will consider nuclear weapons in their arsenal. At the present time, we see evidence of nuclear proliferation among smaller countries regardless of international restraints. There are at least two situations where detonation of nuclear weapons may benefit society and nuclear technology should be preserved. The first such situation is an impending asteroid collision with earth. The latter incident is a hostile alien invasion. President Ronald Reagan remarked about this problem, “I occasionally think how quickly our differences worldwide would vanish if we were facing an alien threat from outside of this world”.

Previously, it was shown that an inexpensive zinc/natural carbon/graphite air fuel cell could sustain an electrical current for many months.(Goldberg, 2015) The chemistry of this zinc air fuel cell was fundamentally different from other zinc air fuel cells because water was consumed along with zinc and oxygen. The proposed chemistry of this zinc air fuel cell was:

Zn→Zn⁺²+2e⁻ Anode

½O₂+H₂O→2OH⁻ Cathode

in which Zn⁺² and 2OH⁻ were adsorbed onto the natural carbon substance of charcoal, biochar, or coal. This adsorption accounted this cell's longevity. Since the waste products of Zn⁺² and OH⁻ slowly formed ZnO, the internal resistance of the cell rose very slowly. Unfortunately, the type of natural carbon that reliably adsorbed these ions was variable, limiting its development.

In order for the zinc air fuel cell to be competitive with other sources of electricity, the oxidation of zinc needs to be clean with waste by-products such as zincate (Zn(OH)₄²⁻, zinc oxide (ZnO) and zinc hydroxides [(Zn(OH)⁺, Zn(OH)₂, Zn(OH)₃⁻] electrically separated from the current flow, and physically separated from anode and cathode so the internal resistance of the zinc air fuel cell only slowly increases over time.

Previously, it has been shown that the oxidation products of zinc in aqueous solution are dependent upon pH. In solutions with pH above approximately 6.5 hydroxide, zincate and oxide species begin to form and are accelerated as the pH rises until the pH reaches about 13.(Reichle, 1975) In solutions below approximately 6.0, hydrogen is formed at the anode from the hydrogen ions and free electron in solution. Therefore, the optimum pH of the zinc air fuel cell to avoid production of oxide, hydroxides, zincate, and hydrogen is between 6 to 7 or around 13, which is the most common pH with electrolytes that contain potassium hydroxide.

Waste is not the only factor limiting the efficiency and longevity of a zinc air fuel cell. Dendritic growth of zinc, permeability of oxygen at the cathode, pH changes of the electrolyte, hydrogen evolution reactions at the anode, carbonate build up from dissolved carbon dioxide, surface area of the anode and cathode, and corrosion of zinc are other factors that influence the efficiency and longevity of a zinc air fuel cell.(Caramia, 2014)

Previous unpublished results to improve the waste management of a zinc air fuel cell have included using electrolytes of saline sodium citrate buffers and sodium citrate buffers with a pH around 6-7 that would chelate the zinc ions and neutralize the hydroxide ions, but the cells did not perform any better than the traditional zinc air fuel cell, and eventually ZnO would precipitate and increase the internal resistance of the cells.

Unlike the chemistry of most salts, zinc chloride does not simply dissociate into zinc and chloride ions in aqueous solutions. It is known that a 6M solution of zinc chloride in water will produce a highly acidic solution with a pH of approximately 1.(Holleman, 2001) Furthermore, common zinc chloride species dissolved in water are [Zn(OH)₃Cl²⁻, Zn(OH)₂Cl₂²⁻, ZnOHCl₃²⁻], which not only explains the acidity of zinc chloride in aqueous solutions, but also explains the unique chemistry and longevity of the zinc/saline/graphite fuel cell described in this invention.

### DESCRIPTION OF THE DRAWINGS

FIG. 1 is the zinc/saline/graphite fuel cell. Label 1 is the zinc anode. Label 2 is the nonconductive mesh. Label 3 is the graphite anode. Label 4 is the nonconductive structure in which the anode, cathode, mesh and saline electrolyte are contained.

FIG. 2 is the decay curve of the zinc/saline/fuel cell. The x axis is time in days. The y axis is watts.

### DETAILED DESCRIPTION OF THE INVENTION

Much can be learned about fuel cell chemistry by direct observation of the cell. In the zinc air fuel cell, side reactions that form insoluble species such as hydrogen gas, zinc oxide, and zinc hydroxide can be observed while the cell produces electricity in a circuit with a load.

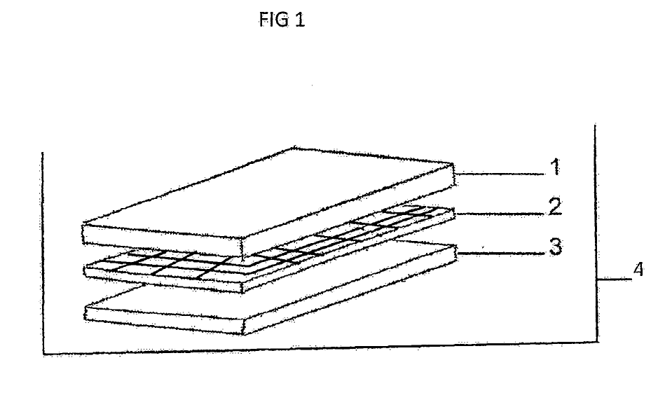

In this invention, two zinc air fuel cells were constructed by sandwiching a zinc plate to a graphite plate with a nonconductive fiberglass mesh between them. (FIG. 1) The plates were then immersed in a saturated aqueous electrolyte of sodium chloride or sodium chloride with pine bark in a nonconductive mesh. Pine bark was chosen since it is one of the few substances that reliably adsorbs zinc ions and neutralizes hydroxide ions.(Cutillas-Barreiro, 2013) The cells were connected to a one thousand ohm resistor and the voltages and pH of the electrolyte solution were monitored daily.

The zinc air fuel cell, without the addition of pine bark, produced the greatest watt hours and longevity compared to the cell with pine bark. The specific energy of the zinc/saline/graphite (124 Wh/kg zinc) was less than the theoretical (1,370 Wh/kg zinc) and actual values (470 Wh/kg zinc) of a traditional zinc air fuel cell, thus implying that the chemistry of the zinc/saline/graphite was fundamentally different than the traditional zinc air fuel cell and consistent with the chemistry of zinc chloride in solutions which contain [(Zn(OH)₃Cl²⁻, Zn(OH)₂Cl₂²⁻, ZnOHCl₃²⁻)] species of zinc hydroxyl chloride. The longevity of the fuel cell could make it a renewable source of energy since cells could be coupled in series and parallel to increase voltage and current. Development of a zinc/saline/graphite fuel cell should be considered, as it is simple, inexpensive, probably renewable (with solar reclamation of zinc), and may provide electricity in the event of an EMP.

### Experimental Section

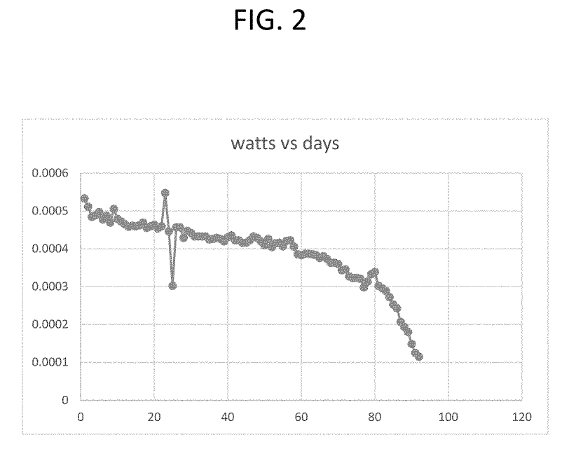

Two zinc air fuel cells were constructed each with a seven gram zinc anode, graphite cathode, nonconductive fiberglass mesh separating the anode and cathode, and an electrolyte of a saturated solution of sodium chlorine in well water. One of the cells incorporated ten grams of pine bark, a substance that is known to neutralize hydroxide ions and adsorb zinc ions. Each cell was connected to a one thousand ohm resistor. Surprisingly, the cell without the additional pine bark outperformed the pine bark cell even though direct observation revealed a cleaner electrolyte solution in the pine bark cell. The opening voltages and current were measured for each cell, and characteristics of each cell are listed in Table 1. A graph of the watts vs time for the cell without pine bark is FIG. 2. The cells were not disturbed except for the periodic addition of well water.

The propose reaction for the zinc/saline/graphite fuel cell is: 3Zn₍ₛ₎+3/2O_{2(g)}+3H₂O+6NaCl₍ₛ₎→Zn(OH)₃Cl²⁻+Zn(OH)₂Cl₂²⁻+ZnOHCl₃²⁻+6Na⁺.

TABLE 1
Characteristics of zinc/saline/graphite fuel cells

| | Saline | Saline and Pine Bark |
|---|---|---|
| Characteristics | N = 92 days | N = 63 days |
| Watt-hours/kg zinc | 124 | 50.4 |
| Voltage (opening) | 0.825 | 0.767 |
| Amperes (opening) | 0.015 | 0.014 |
| Watts (total) | 0.036 | 0.021 |
| Average pH | 6.80 ± 0.21(SD) | 6.80 ± 0.21(SD) |
| Zinc (grams) 0.02 cm × 5 | 7 | 7 |
| cm × 9 cm | | |
| Graphite (grams) 0.5 | 57 | 57 |
| cm × 5 cm × 120 cm | | |
| Pine Bark (grams) | 0 | 10 |
| Water (liters) | 0.25 | 0.25 |
| Sodium Chloride (grams) | 100 | 100 |
| Resistor (ohms) | 1000 | 1000 |

### Benefits of Society

Occasionally difficult scientific problems have simple solutions. The zinc/saline/graphite fuel cell is a reliable and inexpensive source of electricity that circumvents the problem of excessive production of zinc oxide. This fuel cell can be easily constructed without sophisticated knowledge, materials, and equipment, and it may provide electrical energy in the event of an EMP. Future development of the zinc/saline/fuel cell to optimize oxygen permeability at the cathode, improve surface area of the electrodes, and minimize side reactions may increase efficiency. Furthermore, direct chemical conversion to produce electricity is without the inefficiencies of heat engines that produce steam and turn turbines. This invention may resolve energy insecurity among nations and their constituent's, possibly promoting peace.

### REFERENCES

Caramia, V., Bozzini, Benedetto, B. (2014). Material science aspects of zinc-air baterries: a review. Mater Renew Sustain Energy, 3(28), 1-12.

Cutillas-Barreiro, L., Arias-Estevez, M., Novoa-Munoz, J. C., et al. (2013). Copper and Zinc Adsorption Using Pine Bark. WASTES: Solutions, Treatments and Opportunities (2nd International Conference), 353-357.

Goldberg, J. S. (2015). US Patent Publication Number 2015/0037709, Feb. 5, 2015.

Holleman, A. F., Wiberg, E. (2001). Inorganic Chemistry. San Diego: Academic Press, pg. 1298.

Reichle, R. A., McCurdy, K. G., Hepler, L. G. (1975). Zinc Hydroxide: Solubility Product and Hydroxy-complex Stability Constants from 12.5-75 Degrees Centigrade. Can. J. Chem., 53, 3841-3845.

Having described my invention, I claim:

1. A zinc air fuel cell comprised of:
a. a zinc anode
b. a graphite cathode
c. an electrolyte of sodium chloride in water
d. a nonconductive mesh that separates the anode from the cathode
e. a nonconductive container.

2. The fuel cell of claim 1 where the electrolyte is a saturated aqueous solution of sodium chloride.

3. A zinc air fuel cell where the zinc chloride species form complexes with zinc ions and hydroxide ions such that the chemistry of the zinc air fuel cell is: 3Zn₍ₛ₎+3/2O_{2(g)}+3H₂O+6NaCl₍ₛ₎→Zn(OH)₃Cl²⁻+Zn(OH)₂Cl₂²⁻+ZnOHCl₃²⁻+6Na⁺.
